(19) United States
(12) Patent Application Publication
(10) Pub. No.: US 2011/0161248 A1
(43) Pub. Date: Jun. 30, 2011

(54) ONLINE CHARGING CORRELATION IN IMS NETWORKS

(76) Inventors: Yigang Cai, Naperville, IL (US); Xiangyang Li, Beijing (CN)

(21) Appl. No.: 13/060,657

(22) PCT Filed: Sep. 3, 2008
(86) PCT No.: PCT/US2008/075108

§ 371 Date: Feb. 24, 2011

(51) Int. Cl. H04L 12/14

(52) U.S. Cl. 705/400

(57) ABSTRACT

Online charging systems (OCS) and methods are disclosed for correlating online charging requests for a session over an IMS network. The OCS stores online charging requests that are received from a network element serving the session in the IMS network. When a new online charging request is received from another network element, the OCS determines whether the new online charging request relates to the same session as any previously-stored online charging requests. If so, the OCS correlates the online charging requests for the session, and determines a new charging rate for the session based on correlated online charging requests and correlation charging rate rules that are stored in the OCS. The OCS then uses the new charging rate to grant new credit quotas for the session.

### BACKGROUND OF THE INVENTION

1. Field of the Invention

The invention is related to the field of communication networks and, in particular, to correlating credit requests in an Online Charging System (OCS) that are received from network elements of an IMS network to provide more accurate charging for a session.

2. Statement of the Problem

One type of communication network gaining popularity is an IP Multimedia Subsystem (IMS) network. As set forth in the 3^{rd} Generation Partnership Project (3GPP), IMS provides a common core network having a network architecture that allows for various types of access networks. The access network between a communication device and the IMS network may be a cellular network (e.g., CDMA or GSM), a WLAN (e.g., WiFi or WiMAX), an Ethernet network, or another type of wireless or wireline access network. The IMS architecture is initially defined by the 3GPP to provide multimedia services to communication devices over an Internet Protocol (IP) network, as IP networks have become the most cost savings bearer network to transmit video, voice, and data. Service providers are accepting this architecture in next generation network evolution.

For a typical session (or call) within an IMS network, user equipment (UE) of an IMS subscriber initiates the session through an access network, such as a CDMA network, a GSM network, an IP network, a WiFi network, a WiMAX network, etc, by transmitting the appropriate signaling messages (i.e., SIP messages). The access network then routes the signaling messages to the IMS network. If the access network does not use the same signaling protocols as the IMS network (e.g., SIP), then the access network may route the signaling messages to the IMS network through an appropriate gateway. A serving-call session control function (S-CSCF) in the IMS network receives the signaling messages and attempts to establish the session in the appropriate manner. When the session is established, the S-CSCF may also contact one or more application servers (AS) in the IMS network to provide services for the session, such as voicemail, call forwarding, etc.

To provide online charging (prepaid charging) for the session, each of the IMS network elements (e.g., S-CSCF and application server) handling the session may generate online charging requests typically in Diameter Ro protocol. For instance, an IMS network element may transmit a Diameter Credit Control Request (CCR[Initial]) to an Online Charging System (OCS) at an initial triggering event to request a credit quota for the session. Periodically during the session, the IMS network element may transmit one or more Diameter CCRs[Update] to the OCS to request additional credit quotas if needed. At an ending triggering event, the IMS network element may transmit a Diameter CCR[Final] to the OCS to return any unused credits.

When an IMS network element transmits an online charging request (e.g., a Diameter Ro CCR) to the OCS, an Online Charging Function (OCF) in the OCS, such a Session-Based Control Function or Event-Based Control Function, receives the online charging request. The OCF authenticates the subscriber of the session, and transmits charging information to a Rating Engine (RE) in the OCS for a charging rate for the session. The rating engine determines the charging rate for the session, which is a price or cost per unit time of the session, such as $0.05/minute. The rating engine determines the charging rate based on a predefined rating table. The charging rate may depend on a variety of conditions, such as a media type for the session (e.g., voice, video, etc), a service that is being provided during the session (e.g., voicemail, call forwarding, etc), the time of day or day of the week, roaming versus non-roaming, or other conditions. The OCF then grants a credit quota for the IMS network element based on the determined charging rate, and transmits an online charging response (e.g., a Diameter Ro CCA) to the IMS network element that includes the granted credit quota. The IMS network element then performs budget control based on the granted credit quota.

During an IMS session, multiple IMS network elements may be serving the session. For example, the S-CSCF and multiple application servers may be serving a single session. If multiple IMS network elements transmit online charging requests to the OCS, the OCS handles each individual online charging request as described above. More particularly, the rating engine determines a charging rate for each online charging request without consideration of any previous online charging requests. One problem with performing online charging in this manner is that the IMS subscriber may be overcharged or undercharged for the session.

As an example, assume that party A leaves a voice mail message for party B, which is an IMS subscriber. To retrieve the voice mail message, party B initiates a session (call) to an application server that is storing the voice mail message (also referred to as a voice mail server). The application server transmits a first online charging request to the OCS indicating a session involving party B (i.e., the sub-session between party B and the application server). The rating engine in the OCS thus determines a charging rate for the session, which is $0.10/minute. Further assume that when party B is done listening to the voice mail message, party B requests that the application server initiate a call to party A so that party B may converse with party A. In response to the request, the application server extends the session toward party A. The application server transmits a second online charging request to the OCS indicating the session involving party B (i.e., the sub-session between the application server and party A). The rating engine in the OCS determines a charging rate for the second online charging request, which is also $0.10/minute. Thus, the application server will be charging the first sub-session at $0.10/minute, and will be simultaneously charging the second sub-session at $0.10/minute, for a total of $0.20/minute of charging to party B for the overall session. If the rating table indicates that a combined or correlated session from party B to party A through the application server should be charged at $0.10/minute, $0.12/minute, or something less than $0.20/minute, then the IMS subscriber will be overcharged for the session. Because the rating engine determines a charging rate for each individual online charging request, the rating engine is not able to determine the correct charging rate for the overall session.

### SUMMARY OF THE SOLUTION

Embodiments of the invention correlate online charging requests that are received in the OCS so that a correct charging rate may be determined for the overall session. The OCS stores online charging requests or information on online charging requests that are received from IMS network elements that are serving a session. When a new online charging request is received from an IMS network element, the OCS determines whether the new online charging request relates to the same session as any previously-stored online charging requests. If so, the OCS correlates the online charging requests for the session, such as based on an ICID that is included in the online charging requests. The OCS then determines a new charging rate for the session based on correlated online charging requests and correlation charging rate rules that are stored in the OCS. For example, the correlation charging rate rules may indicate that if one online charging request is for a first session involving party B and another online charging request is for a second session involving party B, then the charging rate is $0.10/minute. The OCS then uses the new charging rate to grant credit quotas for the session. Because the OCS correlates online charging requests for the session and determines a charging rate for the session based on the correlated online charging requests, the OCS is able to accurately charge for sessions in the IMS network. The IMS subscriber may thus avoid being overcharged for a session, and the network operator may avoid undercharging the IMS subscriber for the session.

One embodiment of the invention comprises an OCS operable to provide online charging for session in an IMS network. The OCS includes a database, an Online Charging Function (OCF), a correlation system, and a rating engine. The database is operable to store correlation charging rate rules, which indicate the charging rate for a session when multiple online charging requests are considered. The OCF is operable to receive online charging requests for the session from a network element in the IMS network, and store the online charging requests in the correlation system. The OCF is further operable to receive a new online charging request from another network element in an IMS network that is serving the session. The correlation system is operable to determine if the new online charging request relates to the same session as one or more previous online charging requests. If the online charging requests relate to the same session, then the correlation system is further operable to correlate the new online charging request with the previous online charging request(s) to generate correlated online charging requests for the session. The rating engine is operable to determine a new charging rate based on the correlated online charging requests and the correlation charging rate rules. With the new charging rate, the OCF is further operable to grant a credit quota for the new online charging request, and to transmit an online charging response to the requesting network element that includes the granted credit quota.

In some embodiments, the OCF may request that other network elements that were previously granted a credit quota return the granted quota. To do so, the OCF is operable to transmit a credit return request to the network element(s) that was previously granted a credit quota requesting that the previously-granted quota be returned, and to receive another online charging request from network element(s) that includes the returned credit quota. The OCF may then be further operable to grant a new credit quota for the newly-received online charging request based on the new charging rate, and to transmit an online charging response to the requesting network element that includes the new credit quota.

The invention may include other exemplary embodiments described below.

### DESCRIPTION OF THE DRAWINGS

The same reference number represents the same element or same type of element on all drawings.

FIG. 1 illustrates a communication network in an exemplary embodiment of the invention.

FIG. 2 is a flow chart illustrating a method of performing online charging in an OCS in an exemplary embodiment of the invention.

FIG. 3 is a flow chart illustrating a further method of performing online charging in an OCS in an exemplary embodiment of the invention.

FIG. 4 is a flow chart illustrating a method of returning credit quotas in an exemplary embodiment of the invention.

FIG. 5 illustrates an IMS OCS architecture with the addition of a correlation system and a database that stores correlation charging rate rules in an exemplary embodiment of the invention.

FIG. 6 is a block diagram illustrating a correlation system in an exemplary embodiment of the invention.

FIG. 7 is a data structure indicating the parameters for a Diameter Re CorrTariffRequest in an exemplary embodiment of the invention.

FIG. 8 is a data structure indicating the parameters for a Diameter Re CorrTariffResponse in an exemplary embodiment of the invention.

FIG. 9 is a data structure indicating the parameters for a Diameter Re CorrPriceRequest in an exemplary embodiment of the invention.

FIG. 10 is a data structure indicating the parameters for a Diameter Re CorrPriceResponse in an exemplary embodiment of the invention.

FIG. 11 is a message diagram illustrating correlation of online charging requests in an exemplary embodiment of the invention.

### DETAILED DESCRIPTION OF THE INVENTION

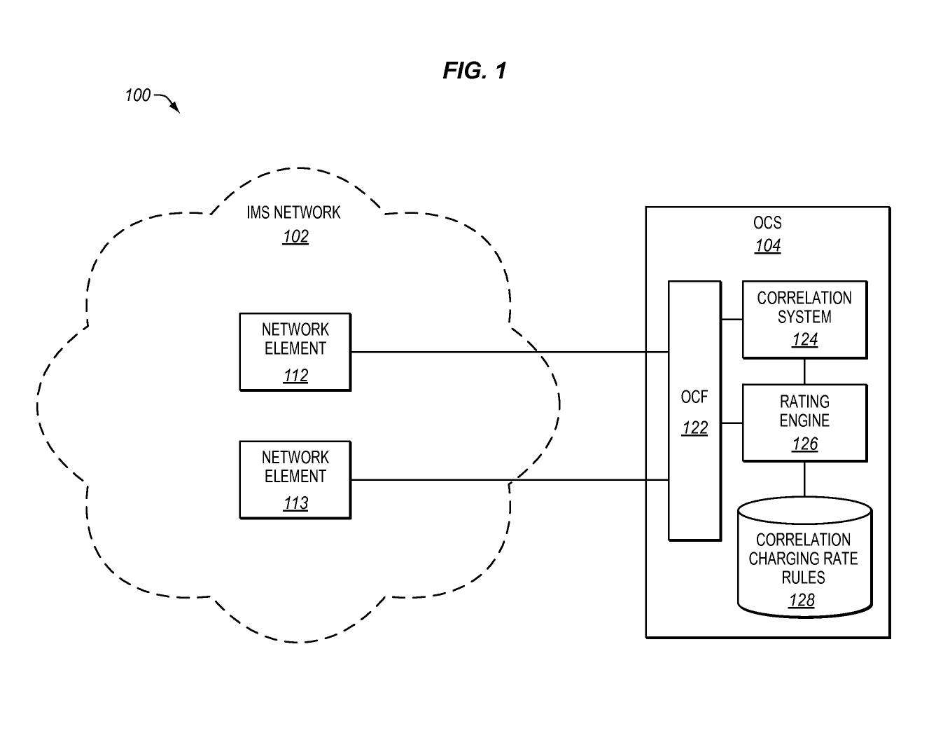

FIGS. 1-11 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 includes an IMS network 102 and an Online Charging System (OCS) 104. Although OCS 104 is indicated as outside IMS network 102, those skilled in the art will appreciate that OCS 104 is part of the charging architecture for IMS network 102 and may be part of IMS network 102. IMS network 102 includes IMS network elements 112-113. Network elements 112-113 comprise any servers, systems, or functions operable to provide communication services and to report charging events to OCS 104. For example, a network element may comprise a P-CSCF, an S-CSCF, an application server, a media gateway, etc. Those skilled in the art will appreciate that IMS network 102 may include many more network elements than are illustrated in FIG. 1.

OCS 104 comprises any system, server, or function operable to perform online charging, such as by receiving online charging requests from network elements 112-113 that are serving a session, determining a charging rate for the session, and granting credit quotas to the network elements 112-113 for the session. In this embodiment, OCS 104 includes an Online Charging Function (OCF) 122, a correlation system 124, a rating engine 126, and a database 128 that stores correlation charging rate rules. OCF 122 comprises any system, server, or function operable to receive online charging requests from network elements 112-113 that are serving a session, and to grant credit quotas to the network elements 112-113 for the session. OCF 122 may represent a session-based control function, an event-based control function, or both. Correlation system 124 comprises any system, server, or function operable to store online charging requests received from network elements 112-113, and to correlate online charging requests that relate to the same session. Rating engine 126 comprises any system, server, or function operable to determine a charging rate for a session. A charging rate comprises a monetary or non-monetary unit cost for services or activities performed in IMS network 102. The charging rate may comprise a tariff for session-based charging, or a price for event-based charging. Database 128 comprises any data structure or function operable to store correlation charging rate rules. Correlation charging rate rules are pre-defined or dynamically-defined policies or conditions that indicate the charging rate for a session when multiple online charging requests are considered.

Assume for this embodiment that network element 112 is serving a session in IMS network 102. At some point during setup of the session or during the session in IMS network 102, network element 112 identifies triggering events for charging, such as based on a Charging Trigger Function (CTF) that is defined to provide online charging for the session. When triggering events are encountered, network element 112 identifies a charging identifier assigned to the session, such as an IMS Charging Identifier (ICID). Network element 112 generates an online charging request, and inserts the charging identifier in the online charging request. The online charging request may be an Initial, an Update, or a Final message. As an example, the online charging request may comprise a Credit Control Request (CCR) [Initial, Update, Final] message as defined in Diameter Ro protocol. During the session, network element 112 transmits one or more online charging requests to OCS 104. Responsive to receiving the online charging requests, OCS 104 operates as follows.

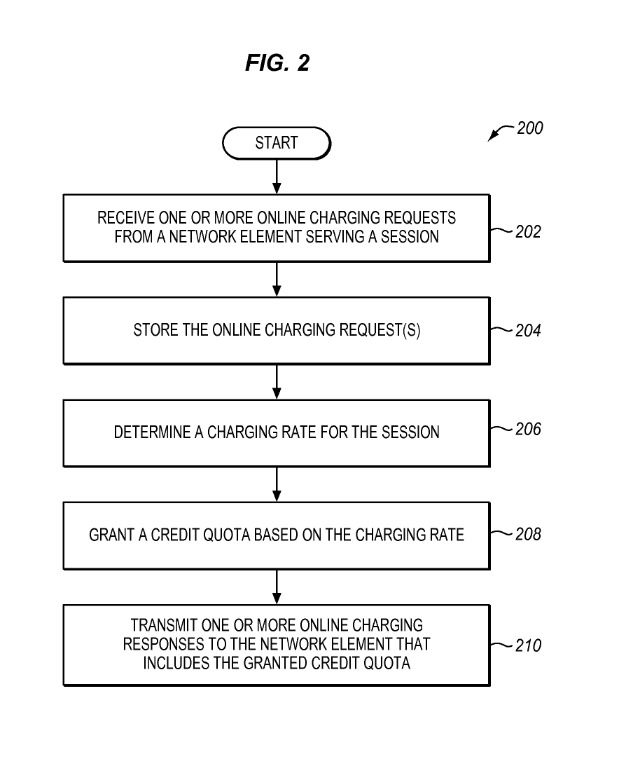

FIG. 2 is a flow chart illustrating a method 200 of performing online charging in OCS 104 in an exemplary embodiment of the invention. The steps of method 200 will be described with reference to communication network 100 in FIG. 1. The steps of the flow chart in FIG. 2 are not all inclusive and may include other steps not shown.

In step 202, OCF 122 in OCS 104 receives the online charging requests from network element 112. In response to receiving the online charging requests, OCF 122 may perform conventional operations, such as authenticating the IMS subscriber. In addition, OCF 122 forwards the online charging requests to correlation system 124. Correlation system 124 then stores the online charging requests in step 204. Correlation system 124 may store the online charging requests in any desired manner. For example, correlation system 124 may process the charging identifier in each online charging request that is received, and then index the online charging requests by charging identifier. Thus, the online charging requests for each individual session in IMS network 102 will be indexed together. When correlation system 124 is described as storing “online charging requests”, those skilled in the art will appreciate that correlation system 124 may store the actual requests, or may store any desired charging information from the online charging requests.

OCF 122 also forwards charging information from the online charging requests to rating engine 126. In response to receiving the charging information, rating engine 126 determines a charging rate for the session in step 206. In determining the charging rate, rating engine 126 may process a session identifier, a service identifier, or any other desired charging information, such as the calling party number, the called party number, a media description, the time of day, an access network identifier, etc. Rating engine 126 then reports the charging rate to OCF 122.

OCF 122 grants a credit quota based on the charging rate in step 208. OCF 122 then generates an online charging response that includes the credit quota, and transmits the online charging response to network element 112 in step 210. Network element 112 then performs budget control based on the granted credit quota. OCS 104 operates in a similar manner responsive to receiving additional online charging requests from network element 112. This above operation indicates online charging when a single network element 112 transmits online charging requests to OCS 104.

In FIG. 1, assume further that network element 113 serves the session in IMS network 102 in addition to network element 112. When serving the session, network element 113 also identifies triggering events for charging, such as based on a CTF that is defined to provide online charging for the session. When triggering events are encountered, network element 113 identifies a charging identifier assigned to the session, such as an ICID. Network element 113 generates an online charging request for the session (e.g., a Diameter Ro CCR), and inserts the charging identifier in the online charging request. Network element 113 then transmits the online charging request to OCS 104. Responsive to receiving a new online charging request from network element 113, OCS 104 operates as follows.

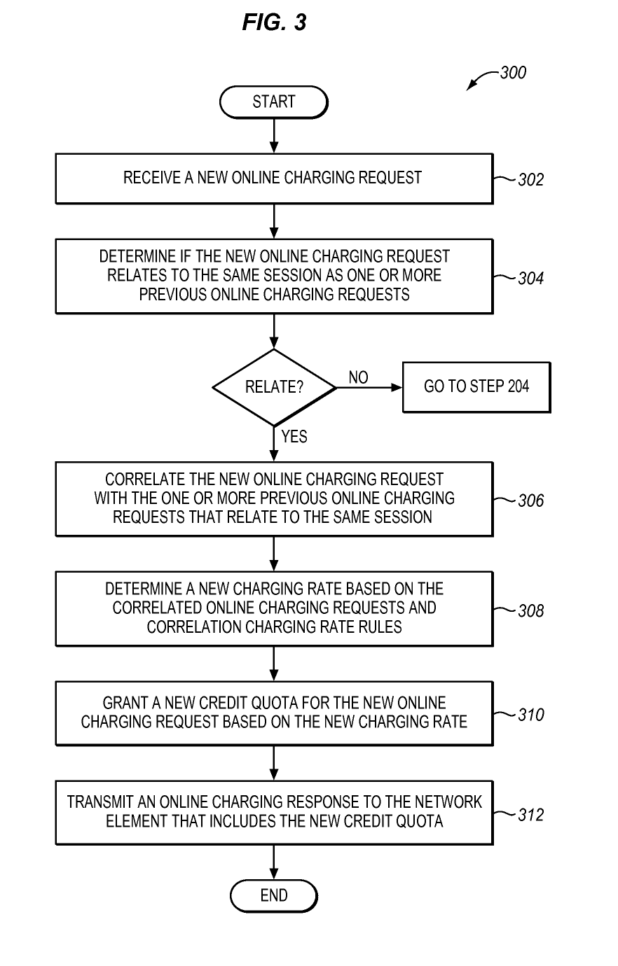

FIG. 3 is a flow chart illustrating a further method 300 of performing online charging in OCS 104 in an exemplary embodiment of the invention. The steps of method 300 will be described with reference to communication network 100 in FIG. 1. The steps of the flow chart in FIG. 3 are not all inclusive and may include other steps not shown.

In step 302, OCF 122 in OCS 104 receives the new online charging request from network element 113. In response to receiving the new online charging request, OCF 122 may perform conventional operations, such as authenticating the IMS subscriber. In addition, OCF 122 forwards the new online charging request to correlation system 124. Correlation system 124 stores the new online charging request. Correlation system 124 also processes charging information in the new online charging request and the previously-stored online charging requests to determine if the new online charging requests relates to the same session as one or more of the previous online charging requests in step 304. For example, correlation system 124 may process the charging identifier (e.g., ICID) in the new online charging request, and then determine if any other of the stored online charging requests share the same charging identifier. If one or more of the stored online charging requests share the same charging identifier as the new online charging request, then these online charging requests relate to the same session.

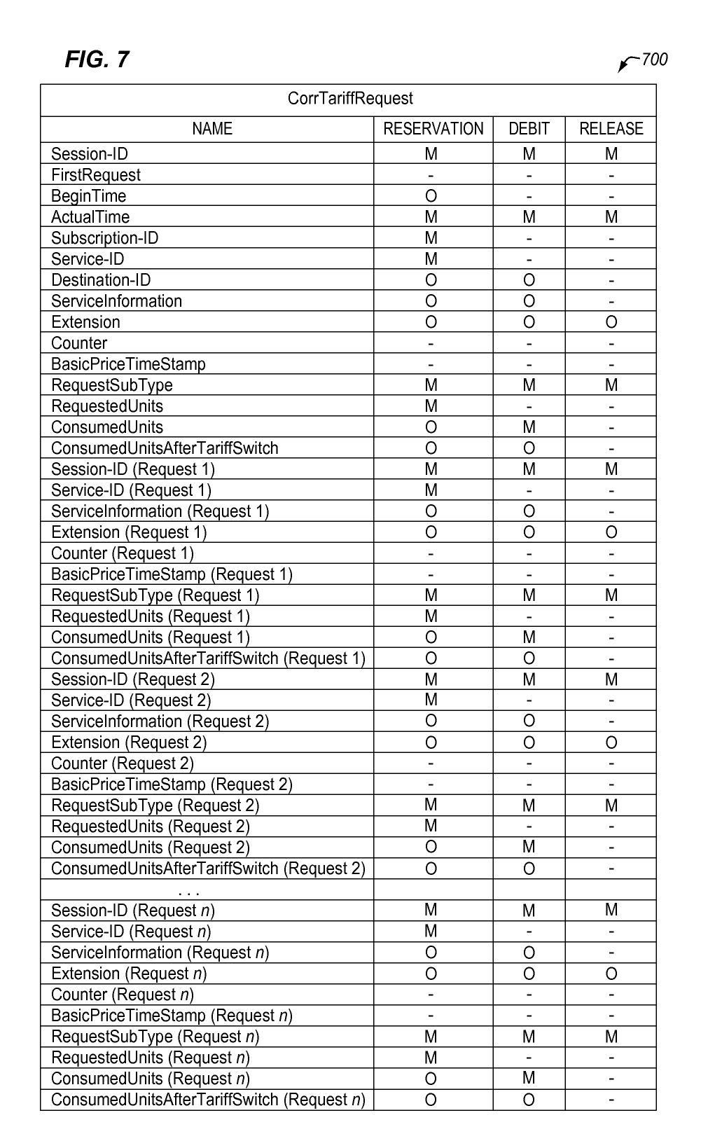

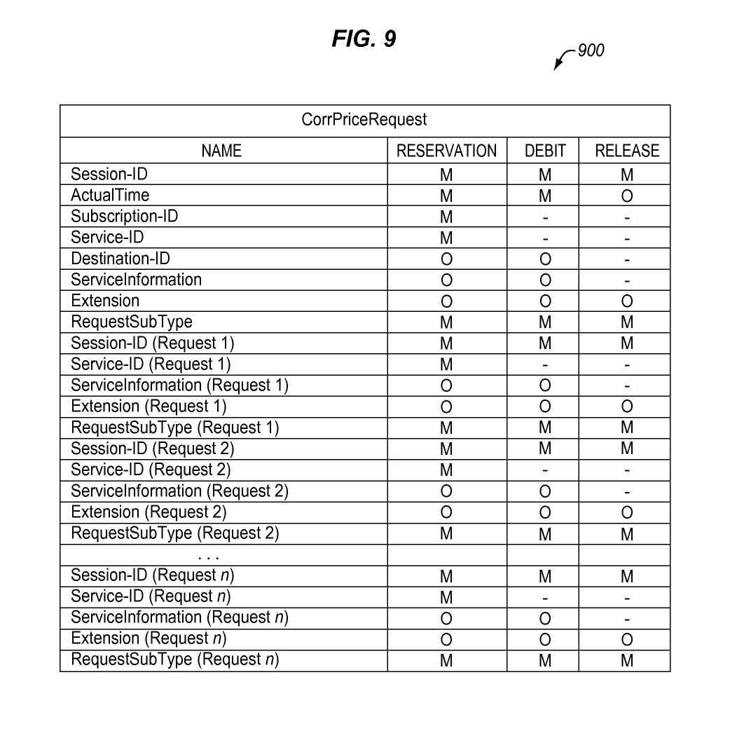

If the new online charging request relates to the same session as one or more of the previous online charging requests, then correlation system 124 correlates the new online charging request with the previous online charging requests that relate to the same session in step 306 to generate correlated online charging requests. To “correlate” the online charging requests, correlation system 124 may group the online charging requests together, extract desired charging information from the online charging requests, or otherwise link the online charging requests or charging information together for processing. For example, correlation system 124 may consolidate the charging information from multiple online charging requests in a Diameter message (e.g., Diameter Re) that includes parameters (see FIGS. 7 and 9) for charging information for each of the individual online charging requests. Correlation system 124 then forwards the correlated online charging requests to rating engine 126, such as in the form of a Diameter message. If the new online charging request does not relate to any of the previous online charging requests, then correlation system 124 stores the new online charging request as being for a new session (see step 204 of FIG. 2).

In step 308, rating engine 126 determines a new (or updated) charging rate based on the correlated online charging requests and the correlation charging rate rules stored in database 128. For example, rating engine 126 may parse each of the online charging requests to identify the media description included in the online charging request. Rating engine 126 may then parse the correlation charging rate rules to determine a charging rate defined for the media description combinations identified in the online charging requests. Rating engine 126 then forwards the new charging rate to OCF 122.

In step 310, OCF 122 grants a new credit quota based on the new charging rate. OCF 122 then generates an online charging response that includes the new credit quota, and transmits the online charging response to network element 113 in step 312. Network element 113 then performs budget control based on the granted credit quota. OCS 104 operates in a similar manner responsive to receiving additional online charging requests from network element 113, network element 112, or other network elements (not shown) in IMS network 102.

When the new charging rate is determined by rating engine 126, the credit quotas that were previously granted to network element 112, which were granted based on an old charging rate, may no longer be valid. Thus, OCS 104 may request that the network elements, which were previously granted credit quotas return the credit quotas as is described below.

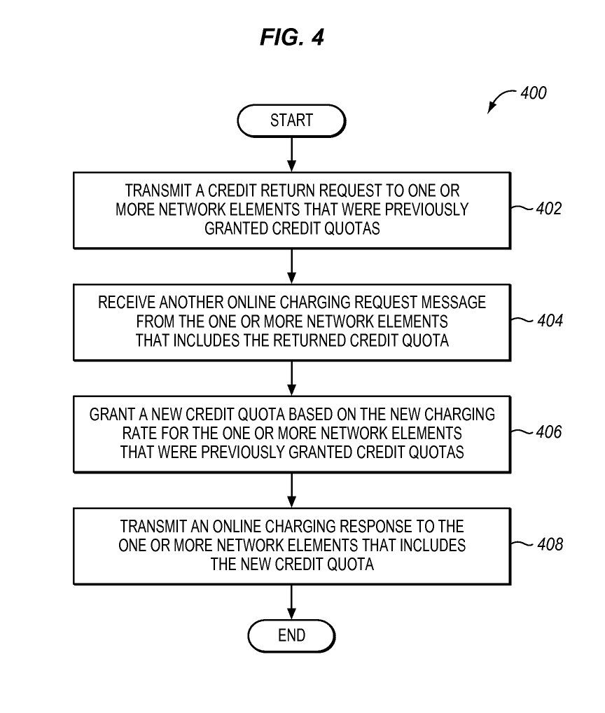

FIG. 4 is a flow chart illustrating a method 400 of returning credit quotas in an exemplary embodiment of the invention. The steps of method 400 will be described with reference to communication network 100 in FIG. 1. The steps of the flow chart in FIG. 4 are not all inclusive and may include other steps not shown.

In step 402, OCF 122 transmits a credit return request to network element 112 and/or any other network element in IMS network 102 that were previously granted credit quotas. For example, OCF 122 may transmit a Diameter Re-Authorization-Request (RAR) to network element 112 requesting that network element 112 return any unused credits from the granted credit quota. Responsive to the credit return request, network element 112 generates an online charging request that includes the remaining credits, such as a Diameter CCR, and transmits the online charging request to OCS 104. In step 404, OCF 122 receives the online charging request from network element 112 that includes the returned credit quota. In step 406, OCF 122 grants a new credit quota based on the new charging rate. OCF 122 then generates an online charging response that includes the new credit quota, and transmits the online charging response to network element 112 in step 408. OCS 104 operates in a similar manner responsive to receiving additional online charging requests from other network elements (not shown) in IMS network 102. Network element 112 then performs budget control using the new credit quota which was based on the new charging rate.

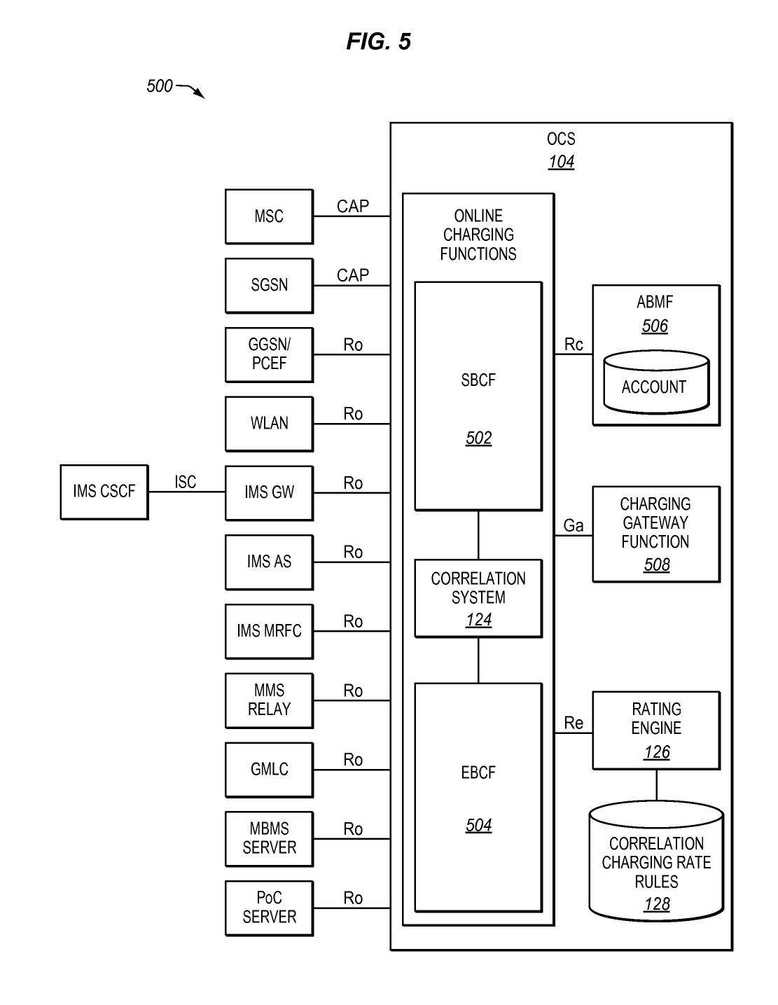

Correlation system 124 and database 128 of correlation charging rate rules may be implemented in the IMS OCS architecture as suggested by the 3GPP. For example, FIG. 5 illustrates an IMS OCS architecture 500 with the addition of correlation system 124 and database 128 in an exemplary embodiment of the invention. As suggested by the 3GPP in Technical Specification 32.296, OCS 104 includes a Session-Based Charging Function (SBCF) 502, an Event-Based Charging Function (EBCF) 504, an Account Balance Management Function (ABMF) 506, a charging gateway function 508, and rating engine 126. SBCF 502 and/or EBCF 504 represent OCF 122 as illustrated in FIG. 1. In addition to these function, OCS 104 also includes correlation system 124 and database 128 that stores correlation charging rate rules. In this embodiment, correlation system 124 communicates with rating engine 126 through a Diameter Re interface.

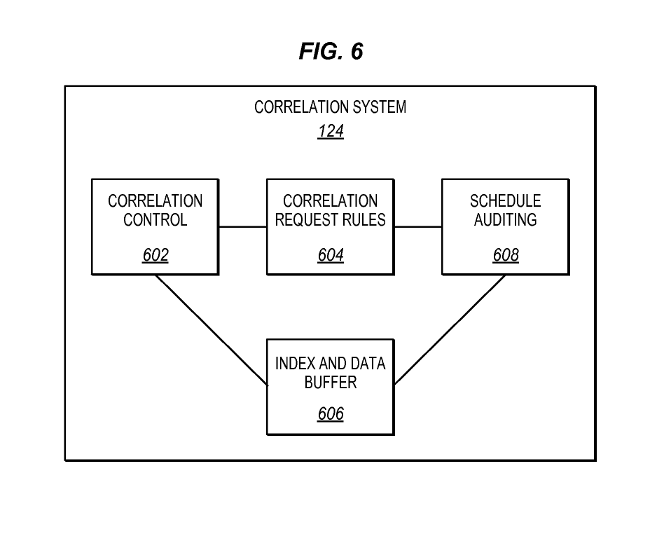

FIG. 6 is a block diagram illustrating correlation system 124 in an exemplary embodiment of the invention. In this embodiment, correlation system 124 includes a correlation control system 602, correlation request rules 604, an index and data buffer 606, and a schedule auditing system 608. Correlation control system 602 is a system that controls how online charging requests are stored and correlated with one another. The correlation request rules 604 define criteria and conditions for correlating different online charging requests. Index and data buffer 606 comprises a temporary storage facility for storing online charging requests which are considered for potential correlation purposes. The index of the stored online charging requests includes basic data, such as ICID, NE ID, NE type, request type, etc. Schedule auditing system 608 is a system that controls the duration of storage of the online charging requests in index and data buffer 606.

When in operation, correlation control system 602 includes service logic to determine whether incoming session or event online charging requests should be considered for correlation. Responsive to receiving an online charging request, the service logic processes the correlation request rules 604 to determine whether the online charging request should be correlated with other previously-stored online charging requests, such as based on an ICID. If so, the service logic stores the online charging request (or its associated information) in index and data buffer 606. The service logic also sets an expiration timer with the request index that is monitored by schedule auditing system 608. The service logic then determines if one or more existing online charging requests stored in index and data buffer 606 shares the same ICID with the received online charging request. If they share the same ICID, then the service logic provides index information to OCF 122. OCF 122 may then initiate Diameter RARs to one or more of network elements 112-113 to pre-empt the existing credit quotas that were granted to network elements 112-113 (session based charging).

If the received online charging request does not share the same ICID as one or more existing online charging requests stored in index and data buffer 606, then the service logic releases the received online charging request after the correlation check. This is referred to as a non-relevant request. OCS 104 responds to non-relevant requests with a normal Diameter CCA that includes a granted credit quota.

According to the embodiments described below, OCF 122 is also operable to construct new Diameter Re requests toward rating engine 126. One of the new Diameter Re requests is for session-based charging and is referred to as a CorrTariffRequest. The CorrTariffRequest is used by OCF 122 to request a tariff for the session being served by network elements 112-113 (session-based charging). FIG. 7 is a data structure 700 indicating the parameters for a Diameter Re CorrTariffRequest in an exemplary embodiment of the invention. The parameters for the CorrTariffRequest may also be referred to as Attribute Value Pairs (AVP).

The parameters of the CorrTariffRequest provide information for the correlated online charging requests to rating engine 126. For example, the parameters of the CorrTariffRequest include information for a first online charging request (request 1), such as a session identifier (session ID), a service identifier, a request sub-type, a requested amount of units, and optionally service information, an extension, etc. The information in these parameters indicates aspects of the session that are used for determining a tariff for the session. For example, the session identifier may indicate a voice call. The request sub-type may indicate a voice mail retrieval call or a voice mail initiated call. The requested amount of units may indicate the duration for a voice mail retrieval call or a voice mail initiated call. The service information may indicate information for a voice mail retrieval call or information for a voice mail initiated call. The parameters of the CorrTariffRequest further include information for a second online charging request (request 2). Depending on how many online charging requests have been correlated for the session, the parameters of the CorrTariffRequest may include information for n online charging requests (request n). The parameters indicated with an “M” are mandatory in this embodiment, and the parameters indicated with an “O” are optional.

After populating the parameters of the CorrTariffRequest with the information for the correlated online charging requests, OCF 122 transmits the CorrTariffRequest to rating engine 126. Rating engine 126 processes the session identifier and the relevant charging information in the CorrTariffRequest and processes the correlation charging rate rules in database 128 (see FIG. 1) to determine the tariff for the session. Because rating engine 126 has the information for each of the correlated online charging requests, rating engine 126 is able to accurately determine the tariff for the overall session. Rating engine 126 then generates a new Diameter Re response referred to as a CorrTariffResponse. The CorrTariffResponse is used by rating engine 126 to report a tariff for the session to OCF 122 (session-based charging).

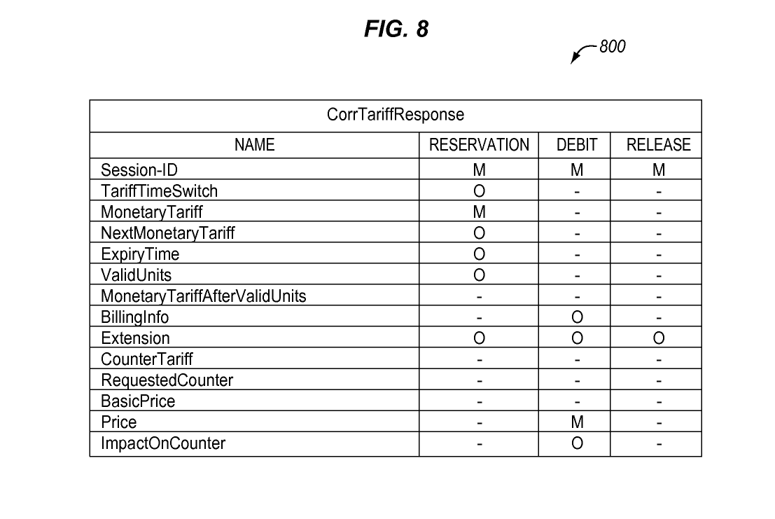

FIG. 8 is a data structure 800 indicating the parameters for a Diameter Re CorrTariffResponse in an exemplary embodiment of the invention. The parameters of the CorrTariffResponse provide charging rate information to OCF 122. For example, the parameters of the CorrTariffResponse include a session identifier (session ID), a monetary tariff, and optionally billing information, an extension, etc.

After populating the parameters of the CorrTariffResponse with the tariff information, OCF 122 grants credit quotas based on the determined tariff for the session. OCF 122 then transmits online charging responses (e.g., Diameter CCA) that include the granted credit quota to network elements 112-113 for budget control.

Another one of the new Diameter Re requests is for event-based charging and is referred to as a CorrPriceRequest. The CorrPriceRequest is used by OCF 122 to request a price for a service performed by a network element 112-113 (event-based charging). FIG. 9 is a data structure 900 indicating the parameters for a Diameter Re CorrPriceRequest in an exemplary embodiment of the invention.

The parameters of the CorrPriceRequest provide information for the correlated online charging requests to rating engine 126. For example, the parameters of the CorrPriceRequest include information for a first online charging request (request 1), such as a session identifier (session ID), a service identifier, a request sub-type, and optionally service information and an extension. The information in these parameters indicates aspects of the session that are used for determining a price for the service being provided for the session. The parameters of the CorrPriceRequest further include information for a second online charging request (request 2). Depending on how many online charging requests have been correlated for the session, the parameters of the CorrPriceRequest may include information for n online charging requests (request n).

After populating the parameters of the CorrPriceRequest with the information for the correlated online charging requests, OCF 122 transmits the CorrPriceRequest to rating engine 126. Rating engine 126 processes the session identifier and the relevant charging information in the CorrPriceRequest and processes the correlation charging rate rules in database 128 (see FIG. 1) to determine the price for the session. Because rating engine 126 has the information for each of the correlated online charging requests, rating engine 126 is able to accurately determine the price for the overall session. Rating engine 126 then generates a new Diameter Re response referred to as a CorrPriceResponse. The CorrPriceResponse is used by rating engine 126 to report a price for a service to OCF 122 (event-based charging).

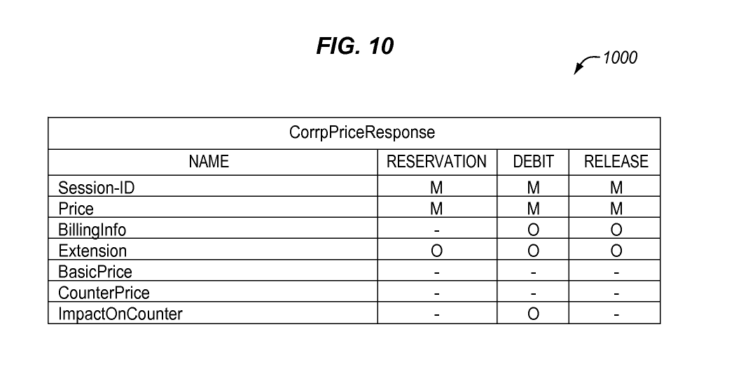

FIG. 10 is a data structure 1000 indicating the parameters for a Diameter Re CorrPriceResponse in an exemplary embodiment of the invention. The parameters of the CorrPriceResponse provide charging rate information to OCF 122. For example, the parameters of the CorrPriceResponse include a session identifier (session ID), a price, and optionally billing information, an extension, etc.

After populating the parameters of the CorrPriceResponse with the price information, OCF 122 grants credit quotas based on the determined price for the service. OCF 122 then transmits an online charging response (e.g., Diameter CCA) to network elements 112-113 for budget control.

In FIG. 6, schedule auditing system 608 continually monitors the duration in which online charging responses are stored in index and data buffer 606. The correlation request rules define how long online charging requests should be stored. If the timer expires, then schedule auditing system 608 removes the stored online charging requests from index and data buffer 606 and generates a log.

### Example

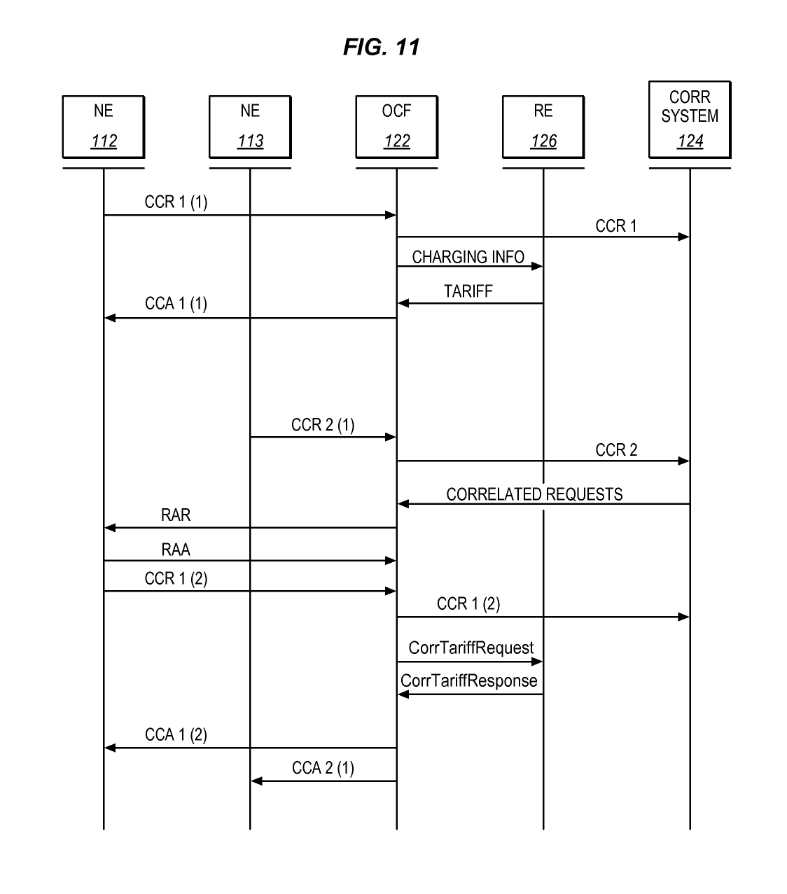

FIG. 11 is a message diagram illustrating correlation of online charging requests in an exemplary embodiment of the invention. Assume that a session has been initiated in IMS network 102 (see also FIG. 1) that is being served by network element (NE) 112. The CTF in network element 112 triggers a first online charging request (CCR 1) with ICID A to OCS 104. Responsive to receiving the first online charging request, OCF 122 authenticates the IMS subscriber. OCF 122 transmits the first online charging request to correlation system 124 responsive to which correlation system 124 stores the first online charging request and sets a correlation timer for potentially-correlated new requests. OCF 122 then transmits charging information from the first online charging request to rating engine (RE) 116. Rating engine 126 determines a first charging rate for the session, and reports the first charging rate to OCF 122. OCF 122 then grants a first credit quota for the session based on the first charging rate, and transmits a first online charging response (CCA 1(1)) with the first credit quota to network element 112. Network element 112 may trigger additional CCR's to OCS 104 responsive to which OCS 104 transmits a CCA with a credit quota based on the first charging rate.

Within the given correlation timer, assume that network element 113 also serves the session in IMS network 102. The CTF in network element 113 triggers a second online charging request (CCR 2 (1)) with ICID A to OCS 104. OCF 122 receives the second online charging request, and forwards the second online charging request to correlation system 124. Correlation system 124 checks if other stored online charging requests include ICID A. If correlation system 124 determines that the first online charging request (CCR 1) has the same ICID A as the second online charging request (CCR 2), then correlation system 124 correlates the two online charging requests, and reports the correlated online charging requests to OCF 122. OCF 122 processes the correlation request rules 604 (see FIG. 6) to determine whether previously-granted credit quotas should be returned. To request the return of previously-granted credit quotas, OCF 122 transmits a Diameter Re-Authorization Request (RAR) to network element 112 requesting the return of any unused credits. Network element 112 answers with a Diameter Re-Authorization Answer (RAA) to OCS 104. The CTF in network element 112 then reports remaining credits by transmitting another online charging request (CCR 1 (2)) to OCS 104. The CCR requests a new credit quota. OCS 104 processes the CCR and returns the remaining credit quota back to the subscriber's account.

OCF 122 then generates a CorrTariffRequest and transmits the CorrTariffRequest to rating engine 126 to rate both CCR 1 and CCR 2 with correlated charging information. Rating engine 126 processes the charging information and the correlation charging rate rules to determine a new tariff for the session. Rating engine 126 then reports the new tariff to OCF 122 in a CorrTariffResponse.

OCF 122 processes the CorrTariffResponse to identify the new tariff, and grants new credit quotas based on the new tariff. OCF 122 then transmits an online charging response (CCA 1 (2)) to network element 112 with the new credit quota. OCF 122 also transmits an online charging response (CCA 2 (1)) to network element 113 with the new credit quota.

When the session ends, both network elements 112-113 report remaining credits back to OCS 104. OCF 122 then updates the subscriber's account. Also, correlation system 124 checks the correlation timer routinely, and if it expires, deletes all relevant CCRs with the same ICID A.

In other embodiments, OCS 104 may support multiple telecommunication network domains, such as Packet Switched (PS), Circuit Switched (CS), and Service domains, as well as the IMS domain. Correlation system 124 will buffer the triggered requests from different network domains with additional charging index data besides just the ICID. For example, if an IMS subscriber surfs the internet using a CDMA data service, then a packet data flow is triggered as bearer charging at OCS 104 when the IMS subscriber uses prepaid charging. If the IMS subscriber initiates an IMS SIP based application service during the session, such as a location service, then the S-CSCF and the application server both trigger online charging requests to OCS 104. Correlation system 124 correlates the online charging requests from both the S-CSCF and the application server with stored packet-switched online charging requests. The correlation rules define that: (1) the bearer level charging takes priority and the packet charging remains the same (no need to empty the existing quota to CDMA PDSN); (2) then, the SIP session is free, so OCS 104 returns a CCA to the S-CSCF with unlimited units; and (3) the location service is relevant charging when considering the correlation among bearer charging and SIP application server charging, so the correlation charging rate rules give a 70% discount. OCS 104 thus returns a CCA to the application server with a discounted tariff.

Additionally, when the IMS subscriber's account balance does not support multiple activities, the correlation request rules 604 (see FIG. 6) may define whether to suppress one or more service activities based on priority of services. The priority of services is pre-defined by the network operators or IMS subscribers. For example, assume that an IMS subscriber is surfing the internet via a packet network with a credit quota already granted, and that the IMS subscriber initiates a voice call via the IMS network. The S-CSCF in the IMS network triggers a new online charging request to OCS 104. Correlation system 124 correlates the online charging requests from both the IMS and packet-switched sessions. OCF 122 figures out that the balance is not sufficient for both the voice call and the packet session. Because the voice session takes higher priority than the packet session, OCF 122 pre-empts the packet session, and uses the returned quota from the packet session for the voice session. To pre-empt the packet session, or to pre-empt any session, sub-session, or service, OCF 122 transmits a terminate message to the network element that is serving the session instructing the network element to terminate the portion of the session being served by the network element.

For Voice Continuity Call (VCC) use cases, the IMS subscriber is able to hand over from one technology network to another technology network, such as from CDMA to WiFi, from GSM to CDMA, and from WiMAX to UMTS. Correlation system 124 will correlate the online charging requests so that OCF 122 is able to pre-empt the quota previously-granted to the prior network and grant a new quota to the present network.

Although specific embodiments were described herein, the scope of the invention is not limited to those specific embodiments. The scope of the invention is defined by the following claims and any equivalents thereof.

We claim:

1. An Online Charging System (OCS), comprising:
a database operable to store correlation charging rate rules that indicate the charging rate for a session when multiple online charging requests are considered;
an online charging function operable to receive a new online charging request from a network element in an IMS network that is serving the session;
a correlation system operable to determine if the new online charging request relates to the same session as at least one previous online charging request, and to correlate the new online charging request with the at least one previous online charging request to generate correlated online charging requests for the session responsive to determining that the online charging requests relate to the same session; and
a rating engine operable to determine a new charging rate for the session based on the correlated online charging requests and the correlation charging rate rules.

2. The OCS of claim 1 wherein:
the online charging function is further operable to grant a credit quota for the new online charging request based on the new charging rate, and to transmit an online charging response to the network element that includes the granted credit quota.

3. The OCS of claim 2 wherein:
the online charging function is further operable to transmit a credit return request to at least one network element that was previously granted a credit quota for the session requesting that the previously-granted quota be returned, and to receive another online charging request from the at least one network element that includes the returned credit quota.

4. The OCS of claim 3 wherein:
the online charging function is further operable to grant a new credit quota for the at least one network element based on the new charging rate responsive to receiving the other online charging request, and to transmit another online charging response to the at least one network element that includes the new credit quota.

5. The OCS of claim 1 wherein:
the online charging function is further operable to transmit a credit return request to at least one network element that was previously granted a credit quota for the session requesting that the previously-granted quota be returned, and to transmit a terminate message to the at least one network element instructing the at least one network element to terminate the portion of the session being served.

6. The OCS of claim 1 wherein the new online charging request and the at least one previous online charging request are received from different network domains.

7. The OCS of claim 1 wherein:
the correlation system is further operable to forward the correlated online charging requests to the rating engine over a Diameter Re interface, wherein the Diameter Re interface includes parameters for charging information for each of the individual online charging requests.

8. The OCS of claim 7 wherein the Diameter Re interface includes parameters for at least a session identifier and a service identifier for each of the individual online charging requests.

9. A method of providing online charging for a session in an IMS network, the method comprising:
storing correlation charging rate rules that indicate the charging rate for a session when multiple online charging requests are considered;
receiving a new online charging request from a network element in the IMS network that is serving the session;
determining if the new online charging request relates to the same session as at least one previous online charging request;
correlating the new online charging request with the at least one previous online charging request to generate correlated online charging requests for the session responsive to determining that the online charging requests relate to the same session; and
determining a new charging rate for the session based on the correlated online charging requests and the correlation charging rate rules.

10. The method of claim 9 further comprising:
granting a credit quota for the new online charging request based on the new charging rate; and
transmitting an online charging response to the network element that includes the granted credit quota.

11. The method of claim 10 further comprising:
transmitting a credit return request to at least one network element that was previously granted a credit quota for the session requesting that the previously-granted quota be returned; and
receiving another online charging request from the at least one network element that includes the returned credit quota.

12. The method of claim 11 further comprising:
granting a new credit quota for the at least one network element based on the new charging rate responsive to receiving the other online charging request; and
transmitting another online charging response to the at least one network element that includes the new credit quota.

13. The method of claim 9 further comprising:
transmitting a credit return request to at least one network element that was previously granted a credit quota for the session requesting that the previously-granted quota be returned; and
transmitting a terminate message to the at least one network element instructing the at least one network element to terminate the portion of the session being served.

14. The method of claim 9 wherein the new online charging request and the at least one previous online charging request are received from different network domains.

15. The method of claim 9 wherein correlating the new online charging request with the at least one previous online charging request to generate correlated online charging requests comprises:
consolidating the charging information from multiple online charging requests in a Diameter Re message that includes parameters for the charging information for each of the individual online charging requests.

16. The method of claim 15 wherein the Diameter Re message includes parameters for at least a session identifier and a service identifier for each of the individual online charging requests.

17. A communication network comprising:
an IMS network including a first network element and a second network element operable to serve a session; and
an online charging system (OCS) operable to perform online charging for the session;
the OCS is operable to receive a first online charging request from the first network element that is serving the session, to store the first online charging request, to determine a first charging rate for the session, to grant a first credit quota for the session based on the first charging rate, and to transmit a first online charging response with the first credit quota to the first network element;
the OCS is further operable to receive a second online charging request from the second network element that is serving the session, to store the second online charging request, to determine if the second online charging request relates to the same session as the first online charging request, to correlate the first and second online charging requests responsive to a determination that the first and second online charging requests relate to the same session, to determine a new charging rate for the session based on the correlated online charging requests, to grant a new credit quota based on the new charging rate, and to transmit an online charging response to the second network element with the new credit quota.

18. The communication network of claim 17 wherein:
the OCS is further operable to transmit a credit return request to the first network element that was previously granted a credit quota requesting that the previously-granted quota be returned, and to receive another online charging request from the first network element that includes the returned credit quota.

19. The communication network of claim 18 wherein:
the OCS is further operable to grant a new credit quota for the first network element based on the new charging rate responsive to receiving the other online charging request, and to transmit another online charging response to the first network element that includes the new credit quota.

20. The communication network of claim 17 wherein the OCS is further operable to set a timer responsive to storing the first online charging request and the second online charging request, and to delete the first and second online charging request after a time period.
